(19) United States
(12) Patent Application Publication
(10) Pub. No.: US 2009/0268548 A1
(43) Pub. Date: Oct. 29, 2009

(54) MICROFLUIDIC SYSTEMS, DEVICES AND METHODS FOR REDUCING DIFFUSION AND COMPLIANCE EFFECTS AT A FLUID MIXING REGION

(75) Inventors: Daniel M. Hartmann, East Lansing, MI (US); Joshua T. Nevill, El Cerrito, CA (US); Gregory A. Votaw, Durham, NC (US); Hugh C. Crenshaw, Durham, NC (US)

Correspondence Address: EKSIGENT TECHNOLOGIES, LLC;c/o SHELDON MAK ROSE & ANDERSON, 100 Corson Street, Third Floor, PASADENA, CA, 91103-3842, US

(73) Assignee: EKSIGENT TECHNOLOGIES, LLC, Dublin, CA (US)

(21) Appl. No.: 11/719,523

(22) PCT Filed: Aug. 10, 2006
(86) PCT No.: PCT/US06/31053

§ 371 Date: May 16, 2007

Related U.S. Application Data
(60) Provisional application No. 60/707,220, filed on Aug. 11, 2005.

(51) Int. Cl. B01F 15/02; B21D 51/16

(52) U.S. Cl. 366/173.1; 29/890.09

(57) ABSTRACT

Microfluidic Systems, Devices and Methods for Reducing Diffusion and Compliance Effects at a Fluid Mixing Region. According to one embodiment, a microfluidic device is provided for combining fluids in a mixing region. The microfluidic device can include a fluid mixing region connected to a first and second microscale channel. The microscale channels can advance fluids to the fluid mixing region. The microscale channels can include constricted flow portions. According to another embodiment, the microscale channels can be connected to waste channels for removing fluid diffused into one of the channels from the other channel. According to yet another embodiment, a microfluidic system is provided for controlling the flow of fluids through the microscale channels for reducing or eliminating diffusion between the channels.

### CROSS-REFERENCE TO RELATED APPLICATIONS

This application claims the benefit of U.S. Patent Application Ser. No. 60/707,220, filed Aug. 11, 2005, the disclosure of which is incorporated herein by reference in its entirety. The disclosures of the following U.S. Provisional Applications, commonly owned and simultaneously filed Aug. 11, 2005, are all incorporated by reference in their entirety: U.S. Provisional Application entitled MICROFLUIDIC APPARATUS AND METHOD FOR SAMPLE PREPARATION AND ANALYSIS, U.S. Provisional Application No. 60/707,373 (Attorney Docket No. 447/99/2/1); U.S. Provisional Application entitled APPARATUS AND METHOD FOR HANDLING FLUIDS AT NANO-SCALE RATES, U.S. Provisional Application No. 60/707,421 (Attorney Docket No. 447/99/2/2); U.S. Provisional Application entitled MICROFLUIDIC BASED APPARATUS AND METHOD FOR THERMAL REGULATION AND NOISE REDUCTION, U.S. Provisional Application No. 60/707,330 (Attorney Docket No. 447/99/2/3); U.S. Provisional Application entitled MICROFLUIDIC METHODS AND APPARATUSES FOR FLUID MIXING AND VALVING, U.S. Provisional Application No. 60/707,329 (Attorney Docket No. 447/99/2/4); U.S. Provisional Application entitled METHODS AND APPARATUSES FOR GENERATING A SEAL BETWEEN A CONDUIT AND A RESERVOIR WELL, U.S. Provisional Application No. 60/707,286 (Attorney Docket No. 447/99/2/5); U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/99/3/2); U.S. Provisional Application entitled MICROFLUIDIC SYSTEMS, DEVICES AND METHODS FOR REDUCING BACKGROUND AUTOFLUORESCENCE AND THE EFFECTS THEREOF, U.S. Provisional Application No. 60/707,386 (Attorney Docket No. 447/99/3/3); U.S. Provisional Application entitled MICROFLUIDIC CHIP APPARATUSES, SYSTEMS, AND METHODS HAVING FLUIDIC AND FIBER OPTIC INTERCONNECTIONS, U.S. Provisional Application No. 60/707,246 (Attorney Docket No. 447/99/4/2); U.S. Provisional Application entitled METHODS FOR CHARACTERIZING BIOLOGICAL MOLECULE MODULATORS, U.S. Provisional Application No. 60/707,328 (Attorney Docket No. 447/99/5/1); U.S. Provisional Application entitled METHODS FOR MEASURING BIOCHEMICAL REACTIONS, U.S. Provisional Application No. 60/707,370 (Attorney Docket No. 447/99/5/2); U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8); U.S. Provisional Application entitled PLASTIC SURFACES AND APPARATUSES FOR REDUCED ADSORPTION OF SOLUTES AND METHODS OF PREPARING THE SAME, U.S. Provisional Application No. 60/707,288 (Attorney Docket No. 447/99/9); U.S. Provisional Application entitled BIOCHEMICAL ASSAY METHODS, U.S. Provisional Application No. 60/707,374 (Attorney Docket No. 447/99/10); U.S. Provisional Application entitled FLOW REACTOR METHOD AND APPARATUS, U.S. Provisional Application No. 60/707,233 (Attorney Docket No. 447/99/11); and U.S. Provisional Application entitled MICROFLUIDIC SYSTEM AND METHODS, U.S. Provisional Application No. 60/707,384 (Attorney Docket No. 447/99/12).

### TECHNICAL FIELD

The subject matter disclosed herein relates to microfluidic systems, devices and methods for fabricating and using the same. More particularly, the subject matter disclosed herein relates to microfluidic systems, devices and methods for reducing diffusion effects at a fluid mixing region.

### BACKGROUND ART

Microfluidic systems have been developed for miniaturizing and automating the acquisition of chemical and biochemical information, in both preparative and analytical capacities. These systems have resulted in decreased cost and improved data quality. Microfluidic systems typically include one or more microfluidic chips for conducting and mixing small amounts of fluids, reagents, or other flowable composition or chemical for reaction and observation. Microfluidic chips can be fabricated using photolithography, wet chemical etching, laser micromachining, and other techniques used for the fabrication of microelectromechanical systems. Generally, microfluidic systems can also include one or more computers, detection equipment, and pumps for controlling the fluid flow into and out of the chip for mixing two or more reagents or other fluids together at specific concentrations and observing any resulting reaction.

Typically, microfluidic chips include a central body structure in which various microfluidic elements are formed for conducting and mixing fluids. The body structure of the microfluidic chip can include an interior portion which defines microscale channels and/or chambers. Typically, two or more different fluids are advanced to a mixing junction or region at a controlled rate from their respective sources for mixing at desired concentrations. The mixed fluids can then be advanced to at least one main channel, a detection or analysis channel, whereupon the mixed fluids can be subjected to a particular analysis by detection equipment and analysis equipment, such as a computer.

A primary challenge in the design of microfluidic systems is the elimination or reduction of noise in the concentration of fluids mixed at the mixing junction. Noise in the fluid mix concentration is any deviation of the actual fluid mix-concentration from the desired fluid mix concentration. This, in turn, affects the quality of data measured by the detection equipment downstream. The quality of data is dependent upon the observed signal-to-noise ratio (SNR). To obtain good analysis data, it is important that the different fluids are mixed in expected concentrations in accordance with an experiment design. Noise can be introduced in the concentration of fluid mixed, for example, by temperature-dependent reagents that cause changes in chemical signals that produce apparent changes in the concentration of fluids as measured by a detector of that chemical signal. Noise can also be introduced by unwanted diffusion of components of one fluid into another fluid at points of convergence of fluids, especially if one of the fluids is held stationary (zero flow) for any time. Additionally, noise can be introduced by thermal expansion or unexpected pressure-driven expansion of components of the microfluidic chip which can cause changes in volume that alter volumetric flow rates in the chip. Noise can also be introduced by thermal expansion or unexpected pressure-driven expansion of any components in the pumps that affect movement of, for example, the plunger relative to the barrel of a syringe pump. Noise can also be introduced by thermal expansion or unexpected pressure-driven expansion of any components in contact with the fluid in the system, such as any tubing that connects different components, such as the pumps and the microfluidic chip. Noise can arise from mechanical instabilities in the microfluidic device or system. The most common source of “mechanical” noise is from the pumps. Any variations in motor speed and any “chatter” in moving parts of the pump, such as the translation stage or piston of a microsyringe, can produce oscillations in the flow of one fluid independent of the intended flows for mixing the fluids, thus resulting in noise. If these occur upstream from the mixing junction, noise can be introduced into the concentration of the fluids mixed at the mixing junction. Even seemingly small amounts of noise becomes particularly problematic due to the small amounts of fluids mixed in the microfluidic system.

Therefore, it is desirable to provide improved microfluidic systems, devices and methods for fabricating and using the same. It is also desirable to improve the design of microfluidic systems for reducing or eliminating any types of noise which may cause an undesired concentration of a fluid mix at a mixing junction.

### SUMMARY

According to one embodiment, a microfluidic device and method is disclosed for combining fluids in a mixing region. The microfluidic device can include a fluid mixing region connected to a first and second microscale channel. The microscale channels can advance fluids to the fluid mixing region. The microscale channels can include constricted flow portions.

According to a second embodiment, a microfluidic device and method is disclosed having waste channels. The microfluidic device can include microscale channels connected to a fluid mixing region for combining fluids at the mixing region. The microfluidic device can also include waste channels connected to the microscale channels.

According to yet another embodiment, a microfluidic system and method is disclosed for controlling the flow of fluids through the microscale channels for reducing or eliminating diffusion between the microscale channels. The microscale channels can be connected to pumps for advancing fluid to a mixing junction. One pump can be controlled to hold fluid in position in a channel for a predetermined time period and then to advance the fluid at a predetermined volumetric flow rate for a second predetermined time period for removing any fluid diffused into the associated channel from another channel. Subsequently, a concentration gradient can be run wherein the diffused fluid has been removed from the channel.

According to another embodiment, a microfluidic device and method is disclosed for combining fluids in a fluid mixing region. The microfluidic device can include a fluid mixing region for receiving fluids for mixing. The mixing region can include a first channel for advancing mixed fluids. The first microscale channel can have a first cross-sectional area. The microfluidic device can also include a second microscale channel connected to the mixing region for advancing a first fluid to the mixing region. The second microscale channel can have a second cross-sectional area less than the first cross-sectional area of the first microscale channel. Further, the microfluidic device can include a third microscale channel connected to the mixing region for advancing a first fluid to the mixing region. The third microscale channel can have a third cross-sectional area less than the first cross-sectional area of the first microscale channel.

It is therefore an object to provide novel microfluidic systems, devices and methods.

### BRIEF DESCRIPTION OF THE DRAWINGS

Exemplary embodiments of the presently disclosed subject matter will now be explained with reference to the accompanying drawings, of which:

FIG. 1 is a schematic diagram of an exemplary embodiment of a microfluidic system for generating and mixing concentration gradients of fluids;

FIG. 2 is a schematic diagram of the channel and mixing region layout of a microfluidic chip;

FIG. 3A is a schematic diagram of a mixing junction showing fluid that has flown out of one channel that has higher pressure into an opposing channel that has a lower pressure;

FIG. 3B is a schematic diagram of a mixing junction showing diffusion occurring between premixing channels at a mixing junction;

FIG. 4 is an exemplary graph comparing the varying flow velocity profiles for fluids in two channels and the resulting concentration gradient;

FIG. 5 is a schematic diagram, of a mixing junction including channels having constricted flow portions for reducing diffusion of fluid between the channels;

FIG. 6 is an exemplary graph of a concentration gradient of fluorescence intensity at the mixing region of a T-junction having channels without constricted flow portions;

FIG. 7 is an exemplary graph of a concentration gradient of fluorescence intensity at a mixing region of a T-junction having constricted flow portions;

FIG. 8A is a schematic diagram of a mixing junction including premixing channels having connection to waste channels for removing “contaminated” fluid;

FIG. 8B is a schematic diagram of a mixing junction including constricted premixing channels having connection to waste channels for removing “contaminated” fluid;

FIG. 9 is a graph showing an exemplary flow velocity profile for reducing undesirable diffusion of fluid by minimizing the time that the fluid in a channel at a mixing junction is held stationary;

FIG. 10 is a graph showing a series of exemplary continuous, variable concentration gradient runs illustrating the effect of the exemplary flow profile of FIG. 9;

FIG. 11 is a graph showing an exemplary flow velocity profile for eliminating or substantially reducing undesirable diffusion of fluid by eliminating the time that the fluid in a channel at the mixing junction is held stationary;

FIG. 12 is a graph showing an exemplary flow velocity profile for ejecting “contaminate” fluid prior to running a concentration gradient;

FIG. 13 is a graph showing a series of exemplary continuous, variable concentration gradient runs for a mixing junction connected to two premixing channels, and employing the exemplary flow profile of FIG. 12;

FIG. 14 is a graph showing an exemplary flow velocity profile for ejecting “contaminate” fluid prior to running a concentration gradient;

FIG. 15 is a schematic diagram of a mixing junction according to another embodiment;

FIG. 16 is a schematic top view of an embodiment of an analysis channel disclosed herein and upstream fluidly communicating microscale channels;

FIG. 17A is a schematic cross-sectional side view of an embodiment of analysis channel disclosed herein and upstream fluidly communicating microscale channel; and

FIG. 17B shows schematic cross-sectional cuts at A-A and B-B of the analysis channel of FIG. 17A.

### DETAILED DESCRIPTION

Microfluidic chips, systems, devices and related methods are described herein which incorporate improvements for reducing or eliminating noise in mixed fluids, or reagents. These microfluidic chips, systems, devices and methods are described with regard to the accompanying drawings. It should be appreciated that the drawings do not constitute limitations on the scope of the disclosed microfluidic chips, systems, and methods.

As used herein, the term “fluid” generally means any flowable medium such as liquid, gas, vapor, supercritical fluid, combinations thereof, or the ordinary meaning as understood by those of skill in the art.

As used herein, the term “vapor” generally means any fluid that can move and expand without restriction except for at a physical boundary such as a surface or wall, and thus can include a gas phase, a gas phase in combination with a liquid phase such as a droplet (e.g., steam), supercritical fluid, the like, or the ordinary meaning as understood by those of skill in the art.

As used herein, the term “reagent” generally means any flowable composition or chemistry. The result of two reagents combining together is not limited to any particular response, whether a chemical or biochemical reaction, a biological response, a dilution, or the ordinary meaning as understood by those of skill in the art.

In referring to the use of a microfluidic chip for handling the containment or movement of fluid, the terms “in”, “on”, “into”, “onto”, “through”, and “across” the chip generally have equivalent meanings.

As used herein, the term “computer-readable medium” refers to any medium that participates in providing instructions to the processor of a computer for execution. Such a medium may take many forms, including but not limited to, non-volatile media, volatile media, and transmission media. Non-volatile media include, for example, optical or magnetic disks. Volatile media include dynamic memory, such as the main memory of a personal computer, a server or the like. Transmission media include coaxial cables; copper wire and fiber optics, including the wires that form the bus within a computer. Transmission media can also take the form of electric or electromagnetic signals, or acoustic or light waves such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other computer-readable medium. Various forms of computer readable media may be involved in carrying one or more sequences of one or more instructions to the processor for execution. Alternatively, hard-wired circuitry may be used in place of or in combination with software instructions to implement the subject matter. Thus, embodiments of the subject matter are not limited to any specific combination of hardware circuitry and software.

As used herein, the term “microfluidic chip,” “microfluidic system,” or “microfluidic device” generally refers to a chip, system, or device which can incorporate a plurality of interconnected channels or chambers, through which materials, and particularly fluid borne materials can be transported to effect one or more preparative or analytical manipulations on those materials. A microfluidic chip is typically a device comprising structural or functional features dimensioned on the order of mm-scale or less, and which is capable of manipulating a fluid at a flow rate on the order of several μl/min or less. Typically, such channels or chambers include at least one cross-sectional dimension that is in a range of from about 1 μm to about 500 μm. The use of dimensions on this order allows the incorporation of a greater number of channels or chambers in a smaller area, and utilizes smaller volumes of reagents, samples, and other fluids for performing the preparative or analytical manipulation of the sample that is desired.

Microfluidic systems are capable of broad application and can generally be used in the performance of biological and biochemical synthesis, analysis, and detection methods. The systems described herein can be employed in research, diagnosis, environmental assessment and the like. In particular, these systems, with their micron scales, nanoliters volumetric fluid control systems, and integratability, can generally be designed to perform a variety of fluidic operations where these traits are desirable or even required. In addition, these systems can be used in performing a large number of specific assays that are routinely performed at a much larger scale and at a much greater cost.

A microfluidic device or chip can exist alone or may be a part of a microfluidic system which, for example and without limitation, can include: pumps for introducing fluids, e.g., samples, reagents, buffers and the like, into the system; detection equipment or systems; data storage systems; and control systems for controlling fluid transport and/or direction within the device, monitoring and controlling environmental conditions to which fluids in the device are subjected, e.g., temperature, current and the like.

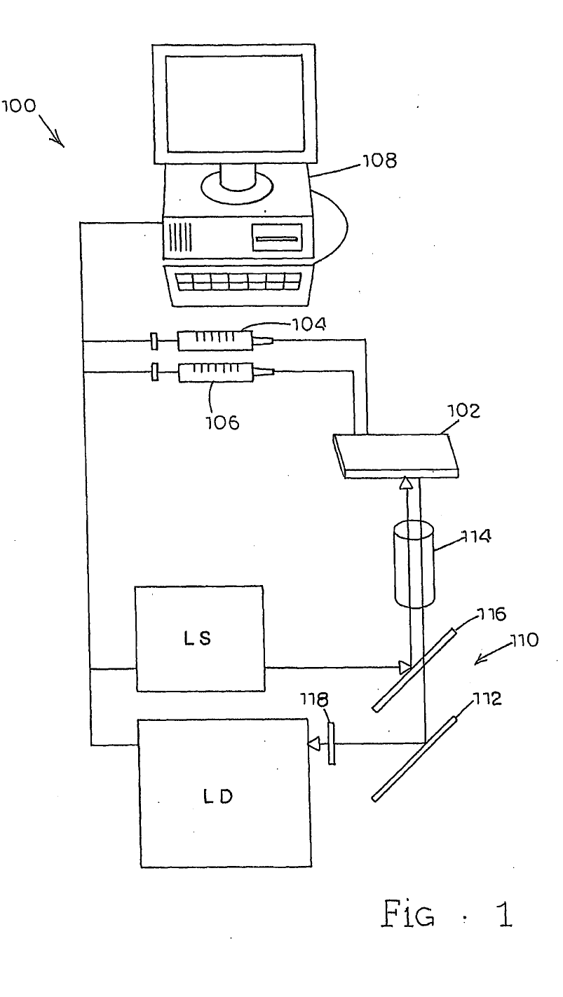

A schematic diagram of an exemplary embodiment of a microfluidic system, generally designated 100, for generating and mixing continuous concentration gradients of fluids is illustrated in FIG. 1. System 100 can include a microfluidic chip 102 having fluid connection to a first and second microfluidic pump 104 and 106 for advancing fluids through chip 102 for mix and analysis. In this embodiment, pumps 104 and 106 are syringe pumps, which can be driven by servo or stepper motors. Alternatively, pumps 104 and 106 can comprise peristaltic pumps, pressure-driven pumps, conducting polymer pumps, electro-osmotic pumps, bubble pumps, piezo-electric driven pumps, or another type of pump suitable for pumping fluids through microfluidic chips. Pumps 104 and 106 can produce volumetric flow rates that are individually controllable by a computer 108.

According to one embodiment, computer 108 can be a general-purpose computer including a memory for storing program instructions for operating pumps 104 and 106. Alternatively, computer 108 can include a disk drive, compact disc drive, or other suitable component for reading instructions contained on a computer-readable medium for operating pumps 104 and 106. Further, computer 108 can include instructions for receiving, analyzing, and displaying information received from detection equipment, generally designated 110, described in further detail below. Computer 108 can also include a display, mouse, keyboard, printer, or other suitable component known to those of skill in the art for receiving and displaying information to an operator.

Computer 108 can operate pumps 104 and 106 to produce smooth, continuous flows in a stable manner. As known to those of skill in the art, some pumps can produce volumetric flow rates as low as approximately one nanoliter per minute. As described further herein, pumps 104 and 106 can be controlled to produce a fluid mix at a mixing junction in microfluidic chip 102 that has a continuously varied ratio over time for producing continuous concentration gradients at the mixing junction. As stated above, many sources, such as mechanical instabilities in syringe pumps, can introduce noise into the fluid mix concentration.

After mixing, a fluid mixture can be advanced to a detection channel/region, or analysis channel/region, on chip 102 and subjected to analysis by detection equipment 110. Typically, the mixed fluids travel a length of channel before reaching the detection channel/region to enable passive mixing of the fluids and sufficient interaction of the components of the fluids, such as reacting chemicals. The detection channel/region can include a point at which measurement, e.g., concentration, of the fluid mixture is acquired by a suitable data acquisition technique. Detection equipment 110 can be operably connected to computer 108 for receiving and storing the measurement acquired from the detection channel/region. Computer 108 can also perform analysis of measurement from detection equipment 110 and present an analysis of the measurement to an operator in a human-readable form. After an experiment has been run and measurement has been acquired, the fluid can flow from the detection channel/region to any suitable waste site for proper disposal.

A microfluidic chip, such as chip 102, can comprise a central body structure in which the various microfluidic elements are disposed. The body structure can include an exterior portion or surface, as well as an interior portion which defines the various microscale channels, fluid mixing regions, and/or chambers of the overall microscale device. For example, the body structures of microfluidic chips typically employ a solid or semi-solid substrate that is typically planar in structure, i.e., substantially flat or having at least one flat surface. Suitable substrates can be fabricated from any one of a variety of materials, or combinations of materials. Typically, the planar substrates are manufactured using solid substrates common in the fields of microfabrication, e.g., silica-based substrates, such as glass, quartz, silicon, or polysilicon, as well as other known substrates, such as sapphire, zinc oxide alumina, Group III-V compounds, gallium arsenide, and combinations thereof. In the case of these substrates, common microfabrication techniques such as photolithographic techniques, wet chemical etching, micromachining, i.e., drilling, milling and the like, can be readily applied in the fabrication of microfluidic devices and substrates. Alternatively, polymeric substrates materials can be used to fabricate the devices described herein, including, e.g., polydimethylsiloxanes (PDMS), polymethylmethacrylate (PMMA), polyurethane, polyvinylchloride (PVC), polystyrene polysulfone, polycarbonate, polymethylpentene, polypropylene, polyethylene, polyvinylidine fluoride, ABS (acrylonitrile-butadiene-styrene copolymer), cyclic olefin copolymers, and the like. In the case of such polymeric materials, laser ablation, injection molding, or embossing methods can be used to form the substrates having the channels and element geometries as described herein. For injection molding and embossing, original molds can be fabricated using any of the above described materials and methods.

Channels, fluid mixing regions and chambers of microfluidic chips can be fabricated into one surface of a planar substrate, as grooves, wells, depressions, or other suitable configurations in that surface. A second planar substrate, typically prepared from the same or similar material, can be overlaid and bonded to the first, thereby defining and sealing the channels, mixing regions, and/or chambers of the device. Together, the upper surface of the first substrate, and the lower mated surface of the upper substrate, define the interior portion of the device, i.e., defining the channels, fluid mixing junctions, and chambers of the device. Alternatively, the surfaces of two substrates can be etched, embossed, or molded and mated together for defining the interior portion of the device.

As mentioned previously, microfluidic chips typically include at least one detection channel, also termed an analysis channel, through which fluids are transported and subjected to a particular analysis. Fluid samples can be advanced from their respective sources to the detection channel by placing the fluids in channels that intersect at a fluid mixing junction. The fluids are suitably advanced through the channels at predetermined fluid velocities to achieve desired concentrations of reagents at the mixing region. Additionally, the fluid velocities can be varied to create gradients of fluid concentration, also known as “concentration gradients,” in which the concentration flowing out of the mixing region varies with time and thus with distance downstream from the mixing region. As referred to herein, a concentration gradient is a change in the concentration of a fluid in a space along some distance of the fluid in the space. As applied to microfluidic devices, for example, a concentration gradient can be considered the concentration change of a fluid along a length of a microscale channel. A concentration gradient can also be considered the concentration change of a fluid as it passes a point over time. Typical experiments can include varying the concentration gradients of fluids advanced to the mixing region and observing the resulting mixed fluids at a downstream detection channel. In order to obtain good analysis data, it is important to precisely control the concentration gradients of fluids at the mixing region. Unanticipated or uncontrolled motions of the fluid can alter the shape of the resulting concentration gradient. Even very small movements of the liquid (equaling volumes of about one nanoliter for example) that would be insignificant for larger systems can be problematic, due to the very slow flow rates used in microfluidic devices. Similarly, diffusion of dissolved chemicals in the liquid, or the liquid itself, can change the concentrations of these chemicals independent of liquid flow. Such diffusional transport can be very important in microfluidic devices, due to the small spatial dimensions of and very slow flow rates in microfluidic channels. Additionally, noise in the concentration gradient can adversely affect analysis data. Concentration gradient noise can be observed as a fluctuating concentration of fluid where the concentration gradient should be constant or smoothly changing with respect to time or space.

In the embodiment of FIG. 1, detection equipment 110 can monitor the progress of resulting reactions of the mixed fluids at the detection channel via fluorescence. For example, as a reaction proceeds at the detection channel: fluorescence can increase due to generation of a fluorescent compound; fluorescence can decrease due to degradation of a fluorescent compound; fluorescence polarization can change due to changes in the rotational diffusion of a fluorescently-tagged molecule, e.g., during binding to a larger molecule; fluorescence lifetime can change due to changes in diffusional mobility or due to changes in chemical environment; and fluorescence wavelength (excitation and/or emission) can change. Similarly, absorption of light by a chemical can be measured or the reagent stream can be sent to a mass spectrometer to measure the amount of specific chemicals.

For fluorescence detection, a fluorescence microscope can be employed. Alternatively, any type of light path known to those of skill in the art can be employed. The excitation light sources can be any suitable light source LS, such as green Helium Neon (HeNe) lasers, red diode lasers, and diode-pumped solid state (DPSS) lasers (532 nanometers). Incandescent lamps and mercury and xenon arclamps in combination with chromatic filters or diffraction gratings with slits can also be used as excitation sources. Excitation sources can include combinations of these, for example, multiple lasers or lasers combined with arclamps and chromatic filters and diffraction gratings with slits. Detection equipment 110 can include a light detector LD for detecting the light fluorescing from and/or passing through the detection channel/region where a reaction occurs. Avalanche photodiodes (APDs) and photo-multiplier tubes (PMTS) can also be used. Light source LS and light detector LD can be coupled to a microscope having mirrors 112, lenses 114, dichroic reflectors 116, and chromatic filters 118. Other optical configurations can be used, such as fiber optic delivery of light from the excitation source to the chip and from the sample in the chip to the photodetector.

Other methods for detection can include phosphorescence, variants of fluorescence (e.g., polarization fluorescence, time-resolved fluorescence, fluorescence emission spectroscopy, fluorescence (Förster) resonance energy transfer), and other non-optical techniques using sensors placed into the fluid flow, such as pH or other ion-selective electrodes, conductance meters, and capture/reporter molecules.

Computer 108 can include hardware and software computer program products comprising computer-executable instructions embodied in computer-readable media for controlling pumps 104 and 106. Computer 108 can also control and analyze the measurements received from detection equipment 110. Computer 108 can provide a user interface for presenting measurements and analysis to an operator and receiving instructions from an operator. Certain concepts discussed herein relate to a computer program product, for causing computer 108 to control pumps 104 and 106, light source LS, and light detector LD. Different methods described herein for controlling the components of system 100 can be implemented by various computer program products. For example, a programmable card can be used to control pumps 104 and 106, such as a PCI-7344 Motion Control Card, available from National Instruments Corporation, Austin, Tex. Methods for controlling pumps 104 and 106 to achieve a desired concentration gradient and receive analysis data from detection equipment 110 can be programmed using C++, LABVIEW™ (available from National Instruments Corporation), or any other suitable software. Such a computer program product comprises computer-executable instructions and/or associated data for causing a programmable processor to perform the methods described herein. The computer-executable instructions can be carried on or embodied in computer-readable medium.

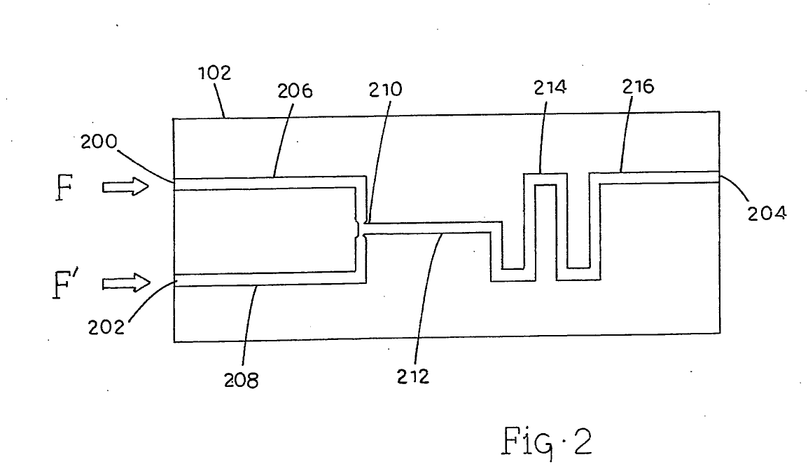

Referring to FIG. 2, a schematic diagram of the channel and mixing region layout of microfluidic chip 102 is illustrated. Microfluidic chip 102 can include two inputs 200 and 202 connected to pumps 104 and 106 (shown in FIG. 1), respectively, for advancing fluids F and F′ through the channels of chip 102. Fluids F and F′ from inputs 200 and 202, respectively, can be advanced by pumps 104 and 106, respectively, through premixing channels 206 and 208, respectively, and combined downstream at a fluid mixing junction 210. Premixing channels 206 and 208 can also function to equilibrate the temperature of fluids F and F′ in the channels to a surrounding temperature. In an alternative embodiment, microfluidic chip 102 can include more than two channels for combining more than two separate, and different if desired, fluids at the mixing junction or at multiple mixing junctions. The channels (such as premixing channels 206 and 208) described herein can be circular, semi-circular, rectangular, nearly circular, nearly semi-circular, or nearly rectangular in cross section.

In the embodiment of FIG. 2, microfluidic chip 102 can operate as a passive mixer such that all mixing occurs by diffusion. Therefore, microfluidic chip 102 can include a mixing channel 212 downstream from mixing junction 210 to allow fluids F and F′ to adequately mix prior to detection downstream. Alternatively, mixing can be enhanced by the inclusion of structures in the microfluidic channels that generate chaotic advection, or mixing can be actively performed by the inclusion of moving, mechanical stirrers such as magnetic beads driven by an oscillating magnetic field. Mixing junction 210 can be configured in any suitable configuration, such as what is known as a T-junction as shown in FIG. 2. The fluid streams from channels 206 and 208 therefore can combine laterally towards each other.

Microfluidic chip 102 can also include a serpentine channel 214 in communication with mixing channel 212 and positioned downstream therefrom. Serpentine channel 214 can operate as an aging loop for allowing a reaction to proceed for a period of time before reaching a detection channel 216. The length of an aging loop and the linear velocity of the fluid determine the time period of the reaction. Longer loops and slower linear velocities produce longer reactions. The lengths of aging loops can be tailored to a specific reaction or set of reactions, such that the reactions have time to complete during the length of the channel. Conversely, long aging loops can be used and shorter reaction times can be measured by detecting closer to mixing junction 210. Waste fluid can be removed from microfluidic chip 102 via waste channel 204.

An exemplary method for generating and mixing concentration gradients using microfluidic system 100 (shown in FIG. 1) will now be described hereinbelow. First, pumps 104 and 106 can be prepared with fluids and connected to microfluidic chip 102. Any suitable method can then be used to purge the channels of microfluidic chip 102 for removing any contaminants, bubbles, or any other substance affecting concentration. Further, configuration and calibration of detection equipment 110 can be effected.

Once microfluidic system 100 has been prepared, concentration gradients can be run through microfluidic chip 102. Pumps 104 and 106 can be activated to establish separate flows of separate, and different if desired, fluids into chip 102 for mixing and measurement. According to one embodiment, the total or combined volumetric flow rate established by the active pumps is maintained at a constant value during the run. In addition, the ratio of the individual flow rates established by respective pumps can be varied over time by individual control, thereby causing the resulting concentration gradient of the mixture to vary with time. The concentration gradient of interest is that of an analyte of interest relative to the other components of the mixture. The analyte of interest can be any form of reagent or component of a reagent. Exemplary reagents can include inhibitors, substrates, enzymes, fluorophores or other tags, and the like. As the reaction product passes through detection channel/region with varying concentration gradient, detection equipment 110 samples the resulting reaction flowing through at any predetermined interval. The measurements taken of the mixture passing through the detection channel/chamber can be temporally correlated with the flow ratio produced by pumps 104 and 106, and a response can be plotted as a function of time and concentration.

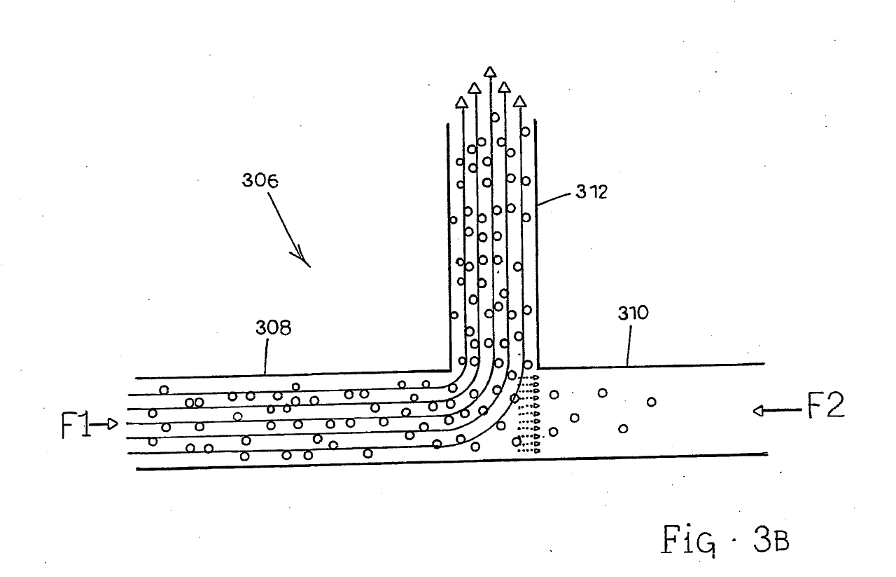

FIG. 4 depicts one such concentration gradient. For this gradient, pumps 104 and 106 were controlled such that the combined flow rate of the pumps was 10 nl/min. The commands to one pump, containing buffer with a fluorescent molecule (0.5 μM resorufin), are shown in trace 400. The commands to the other pump, containing buffer without a fluorescent molecule, are shown in trace 402. The intensity of the fluorescence measured downstream from mixing channel 212 is shown as trace 404. Initially, pump containing fluorophore (trace 400) was stationary for 2 minutes while the other pump without fluorophore flowed at 10 nl/min (trace 402), producing a low measured fluorescence to about 190 seconds. Next, the pump without fluorophore (trace 400) was linearly decelerated over 2 minutes to zero nl/min as the pump with fluorophore (trace 402) was linearly accelerated to 10 nl/min, creating a linearly increasing concentration gradient evident in the measured fluorescence (trace 404) from about 190 to 310 seconds. Next, the pump without fluorophore (trace 400) was held at zero nl/min, and the pump with fluorophore (trace 402) was held at 10 nl/min, creating a maximum measured fluorescence (trace 404) from about 190 to 320 seconds. Thus, the two pumps were varied from 0% to 100% of the combined flow rate, creating a series of increasing and decreasing concentration gradients. As expected, the measured fluorescence in trace 404 matched the instructed flows in trace 400 but temporally lagged because the measurement was made downstream from mixing channel 212. A systematic error in the resulting concentration gradient was evident when the expected gradient 410 was compared to the measured fluorescence 406. A “shoulder” was present in the measured fluorescence in which the fluorescence rose later than expected, and when it did rise, it rose very rapidly to the expected fluorescence. A shoulder was also evident in the linearly decreasing concentration gradient at reference numeral 408.

Three mechanical phenomena can cause such “shoulders” in the resulting concentration gradient relative to the gradient expected from the ratio of volumetric flow rates generated by the pumps: (1) compliance-driven flow in microfluidic chip 102 or in any fluidic component in communication with microfluidic chip 102; (2) diffusion between fluids F and F′ in premixing channels 206 and 208, respectively, connected at mixing junction 210; and (3) failure of pumps 104 and 106 to execute the commanded flow rate because the precision of the pump is exceeded at flow rates at or near zero due to, for example, stiction in the mechanism or insufficient resolution of the encoder for servomotors.

Referring again to FIG. 2, compliance can cause the volume of a component of the microfluidic system to change as pressure changes in that component. Pressure varies with volumetric flow rate. Volumetric flow rates through inputs/premixing channel 200/206 and 202/208 are intentionally varied to create the concentration gradients, so the pressure in these and all connected components also vary. If the volume inside a component varies, then the volumetric flow rate leaving that component also varies. For example, if volumetric flow rate into premixing channel 206 increases, then pressure inside this channel also increases. If premixing channel 206 expands in response to this increased pressure, then the outflow from premixing channel 206 will be less than the inflow while premixing channel 206 expands. This causes a temporary reduction in expected flow at mixing junction 210. Furthermore, when the volumetric flow rate decreases, the pressure drops, and now the volume of the compliant component decreases, causing a temporary elevation in expected flow at mixing junction 210.

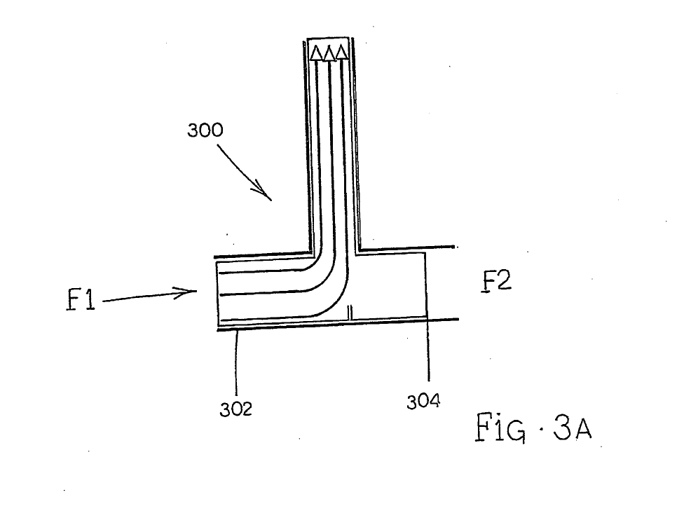

When the pressure on one side of the input junction exceeds the pressure on the other side of the junction, then compliance on the lower pressure side can cause fluid from the high pressure side to flow into the low pressure side. Referring to FIG. 3A, a schematic diagram of a mixing junction, generally designated 300, showing fluid F1 flowing out of one channel 302 that has a higher pressure into an opposing channel 304 that has a lower pressure. When flow in channel 302 is next increased, fluid F1 from channel 302 can be pushed out first. The result is a “shoulder” in the concentration gradient.

A similar situation arises from diffusion which can result in “shoulders” in the concentration gradient of mixed fluids. Referring to FIG. 3B, a schematic diagram of a mixing junction, generally designated 306, showing diffusion occurring between premixing channels at a mixing junction is illustrated. Mixing junction 306 can include a first channel 308 with a moving flow of fluid F1 and a second channel 310 containing a fluid F2 held stationary and adjacent to the flow of fluid F1 from first channel 308. Fluid F1 in first channel 308 contains fluorescent molecules shown flowing into a mixing channel 312. Additionally, fluorescent molecules from first channel 308 diffuse into fluid F2 held stationary in second channel 310. When fluid F2 in second channel 310 is advanced to mixing channel 312 for forming a concentration gradient, the fluorescent molecules diffused into second channel 310 are pushed into mixing channel 312 first. The result is that the concentration gradient of fluid F1 from first channel 308 is not linear, as expected, at the beginning of the concentration gradient. Rather, a “shoulder” forms in the concentration gradient because of the diffusion of the detected molecules into fluid F2 in second channel 310.

Importantly, diffusive flux of molecules also occurs from stationary fluid F2 in channel 310 into the stream of fluid F1 flowing from channel 308. This also can create errors in the portion of the gradient in which the concentration of the molecules of fluid F2 is expected to be low when the molecules of fluid F2 diffuse into the stream of fluid F1 effectively contaminate the flow of fluid F1. This can be extremely important when the concentration of an analyte must go to zero, as for example, when testing inhibitors of an enzyme reaction. Such diffusion can limit the range of concentrations that can be mixed in a microfluidic system. For example, if a first fluid stream contains water and a second fluid stream contains, for example, glucose at 1 molar in water, then diffusion of glucose from the second fluid stream into the first fluid stream prevents the concentration of glucose from reaching zero in the mixing channel, for example only reaching 1 mM. Thus, diffusion effectively limits the range of concentration in the system to three logs of dilution (1 mM to 1 M).

Referring to FIG. 4, which illustrates an exemplary graph comparing the varying flow velocity profiles for fluids in channels 308 and 310 (shown in FIG. 3) as generated by a first and second pump, respectively, and the resulting concentration gradient. When the first pump is at 100% and the second pump is at 0%, the fluid in second channel 310 is held stationary. Thus, either fluorescent molecules from first channel 308 diffuse into the fluid in second channel 310 when the second pump is at 0% or the fluorescent molecules flow, due to compliance, into second channel 310. Conversely, when the second pump output is at 100% and the first pump output is at 0%, the result is that fluid in first channel 308 is held stationary. Now, fluorescent molecules in channel 308 diffuse into the flow from channel 310, causing the concentration of fluorophore in first channel 308 to decrease near the junction, or non-fluorescent fluid from second channel 310 flows due to compliance into channel 308.

Graph line 404 represents the concentration gradient of fluorescent molecules present at mixing channel 312, and detected with detection equipment 110 (shown in FIG. 1) at a point downstream from the junction. As shown, a shoulder results from the diffusion of fluid, or flow of fluid due to compliance, between channels 308 and 310. When the pump output corresponding to first channel 308 increases and the pump output for second channel 310 decreases at approximately time 590, the concentration of fluorophore in mixing channel 312 begins to rise, as shown in line 404. It is evident a shoulder results at approximately time 680, shown at reference numeral 406, on the rising concentration gradient. Additionally, for example, when the pump output corresponding to first channel 308 decreases and the pump output for second channel 310 increases at approximately time 846, the concentration of fluorophore in mixing channel 312 decreases. Again, a shoulder is visible in this decreasing concentration gradient at approximately time 911, shown at reference numeral 408. Graph line 410 shows the desired concentration gradient and illustrates the difference between the desired concentration gradient (shown by graph line 410) and the actual concentration gradient (shown by graph line 406).

### Constricted Flow Portion at a Fluid Mixing Junction

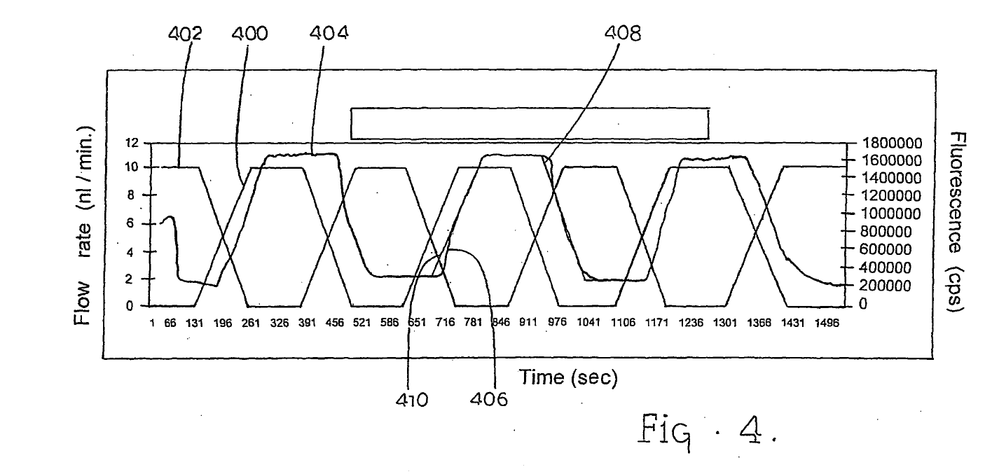

As stated above, shoulders in a concentration gradient at a mixing channel can result when fluids from one channel diffuse into another channel at a fluid mixing junction. Although not intended to be bound by theory, the diffusion of the fluid at this point can be described by Fick's law:

$$F = {D}_{c} A \frac{Δ C}{Δ x}$$

where F is the flux of chemical (moles·second⁻¹), D_{C} is the diffusion coefficient (centimeter²·second⁻¹), ΔC is the concentration difference between two points, and Δx is the distance between the points (thus, ΔC/dx is the concentration gradient, moles·centimeter⁻³·centimeter⁻¹=moles·centimeter⁻⁴), and A is the cross-sectional area, perpendicular to the gradient (in this case, the cross-section area of channel 518 (shown in FIG. 5).

Based on this equation, such diffusion can be reduced by decreasing the cross-sectional area of the input channels near the fluid mixing junction. This can be accomplished in one of two ways: (1) the cross-sectional areas of the two input channels can be made as small as possible—smaller than the mixing channel; or (2) the cross-sectional area of the portion of the input channels near the fluid mixing junction are reduced to form a constricted flow portion. The second approach has the advantage of minimizing the pressure drop in the input channels and, thus, the pressure required to push fluids through microfluidic chip 102. Additionally, if the second approach is used, then diffusion into a channel can be reduced by increasing Δx which is accomplished by increasing the length of the constricted portion of the channel.

FIG. 5 illustrates a schematic diagram of a mixing junction, generally designated 500, including channels having constricted flow portions for reducing diffusion of fluid between the channels. Mixing junction 500 can be a portion of a microfluidic chip and can include a first and second channel 502 and 504 for advancing fluids to a mixing channel 506. A first and second fluid F and F′ can be advanced to mixing channel 506 through channels 502 and 504, respectively, in the direction of arrows 508 and 510, respectively. Fluids F and F′ can then mix at a mixing region 512 and advance to other elements of the microfluidic system (not shown) in the direction of arrow 514. In an alternative embodiment, the mixing junction can include more than two channels including constricted flow portions for advancing fluids F and F′ to a mixing region.

As stated above, sometimes the fluid flow velocities for fluids F and F′ in channels 502 and 504 are varied for achieving a desired concentration gradient at mixing channel 506. When the fluid flow velocity of one of channels 502 and 504 is reduced to zero and fluid F or fluid F′ is held stationary in the channel, fluid F or F′ from the other channel can diffuse into the channel having fluid F or F′ held stationary. Channels 502 and 504 can include constricted flow portions 516 and 518, respectively, for reducing the diffusion of fluid F or F′ into the channel. In this embodiment, constricted flow portions 516 and 518 are positioned along the length of the channels 502 and 504, respectively, near the junction of the ends of channels 502 and 504, respectively. Alternatively, constricted flow portions 516 and 518 can be positioned anywhere along the length of channels 502 and 504, respectively, for reducing diffusion of fluid F or F′ past the constricted flow portion. Generally, the further the constricted flow portions are placed from the mixing junction, the lower the effectiveness of the constricted flow portions for reducing diffusive effects.

Constricted flow portions 516 and 518 include cross-sectional areas that are smaller than the portions of channels 502 and 504, respectively. As shown, portions 520 and 522 of channels 502 and 504 include cross-sectional areas larger than constricted flow portions 516 and 518. In this embodiment, the cross-sectional area of channels 502 and 504 generally becomes smaller as the channel extends closer to mixing channel 506.

The length of the constricted flow portions, for example constricted flow portions 516 and 518, can be increased to achieve reduced diffusion. As Fick's law demonstrates, this has the effect of decreasing the concentration gradient and, therefore, the diffusive flux. The entire microscale channel upstream of mixing region 512 could be made similarly narrow and shallow, but this would require much higher pressures to permit similar volumetric flow rates.

Similarly, flow into channel 518 from channel 516 driven by compliance and a pressure difference across mixing region 512 can be minimized by increasing resistance to flow in channel 518. Increasing the resistance to flow allows flow from upstream of channel 518 to fill the volume increase driven by compliance. Decreasing the cross-sectional area and increasing the length of channel 518 can increase the resistance to flow, as shown by the Poiseuille equation for viscous flows.

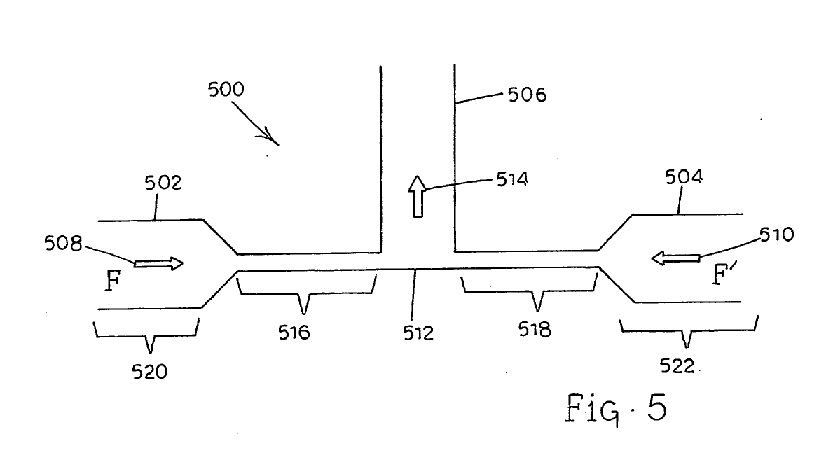

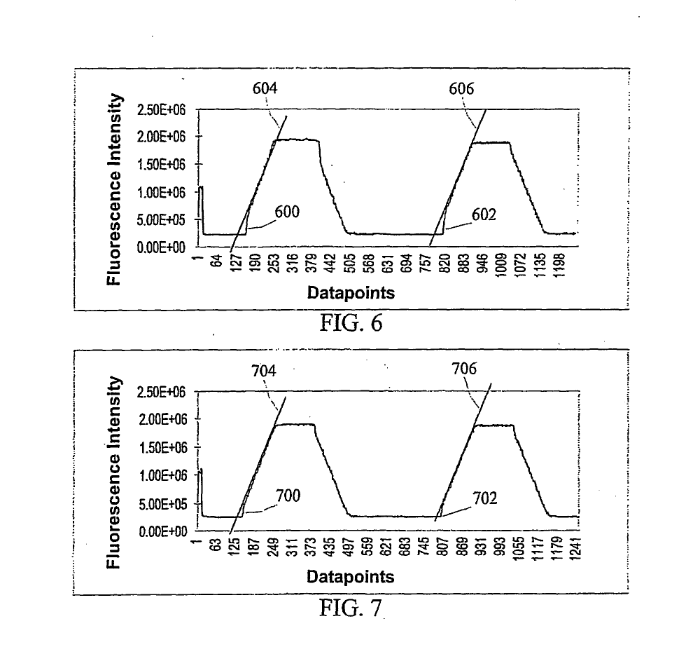

FIG. 6 illustrates an exemplary graph of a concentration gradient of fluorescence intensity at the mixing region of a T-junction having channels without constricted flow portions. Shoulders generated by either diffusion or compliance are evident at reference numerals 600 and 602. Lines 604 and 606 show a portion of the expected concentration gradient. For comparison, FIG. 7 shows an exemplary graph of a concentration gradient of fluorescence intensity at a mixing region of a T-junction having constricted flow portions and subject to the same conditions as the T-junction of FIG. 6. As shown, shoulders are still evident at reference numerals 700 and 702; however, they are made much smaller by the addition of constricted flow portions. Lines 704 and 706 show a portion of the expected concentration gradient.

Any decrease in the cross-sectional area of a channel to create a constricted flow portion will decrease diffusive flux and compliance-driven flow and, thereby, reduce the magnitude of shoulders. This decrease in cross-sectional area can be achieved by narrowing the channel, making the channel shallower, or both.

### Waste Channels

As stated above, shoulders in a concentration gradient can result when fluids from one channel diffuse or flow into another channel at a fluid mixing junction. As shown in FIGS. 3A and 3B, “contaminate” fluid is primarily located at the end of the channel having stationary fluid. Once the fluid flow velocity in the channel is increased, the “contaminate” fluid is pushed out of the channel and shoulders result. Shoulders can be reduced by removing the “contaminate” fluid in the channel near the mixing junction prior to advancing the fluid in the channel.

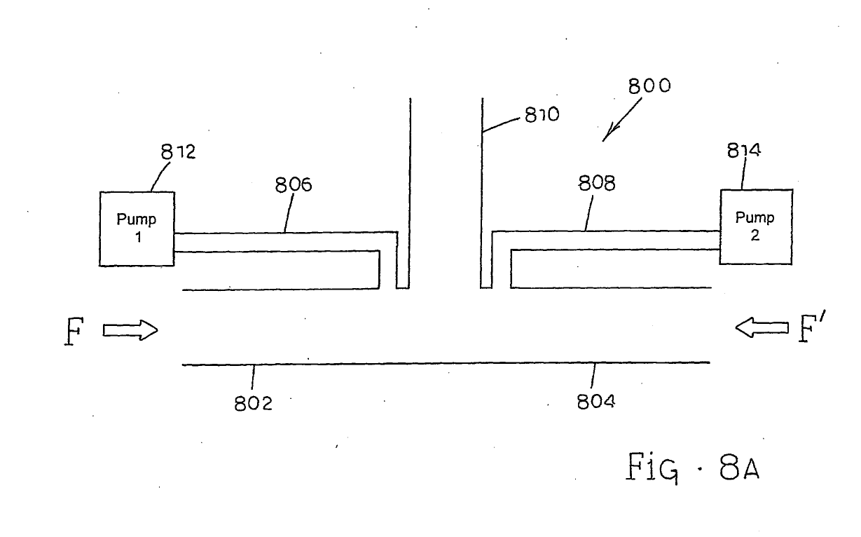

FIG. 8A illustrates a schematic diagram of a mixing junction, generally designated 800, including premixing channels 802 and 804 having connection to waste channels 806 and 808, respectively, for removing “contaminate” fluid. Waste channels 806 and 808 can be connected to channels 802 and 804, respectively, at a portion near mixing channel 810.

Waste channels 806 and 808 can be operatively connected to a first and second pump 812 and 814, respectively, for removing a desired amount of fluid F or F′ from a portion of premixing channels 802 and 804, respectively. In one embodiment, only “contaminate” fluid is removed from premixing channels 802 and 804 without removing other “non-contaminate” fluid in the channel. According to another embodiment, pumps 812 and 814 are controlled to remove “contaminate” fluid from the associated waste channel 806 or 808 after fluid in the premixing channel 802 and/or 804 has been stationary for a predetermined time and prior to advancing fluid through the premixing channel.

Fluid flow out of the waste channels, relative to the reaction flow, can be regulated passively, by fabrication with appropriate channel diameters to control flow resistances in the waste and premixing channels. Alternatively, flow out of waste channels 806 and 808 can be achieved by active valving of waste channels 806 and 808 (on-chip or off-chip). For passive regulation, a small percentage of total flow can always flow out of the waste channel. When, for example, flow in channel 802 is zero and flow in channel 804 is nonzero, then a small flow can persist in waste channel 806. This flow can be of fluid from the intersection of channels 802 and 804 which is where contaminate fluid is generated by diffusion, thus fluid flow out of 806 removes contaminate fluid. Note that flow out of waste channel 808 can occur at this time, but it is not contaminate. There is a small amount of non-contaminate fluid that can be lost in the system. According to one embodiment, pumps 812 and 814 may be excluded because pressure at the mixing point can push contaminated fluid out through channels 806 and 808. For active valving, valves regulate the flow out of waste channels 806 and 808 to reduce loss of fluid out of the waste channels. These valves open only when flow in the respective channel is at zero, thus when flow in channel 802 goes to zero and flow in channel 804 is nonzero, the valve regulating waste channel 806 opens while the valve regulating waste channel 808 remains closed. For active pumping, the valves are replaced by, or augmented by, pumps 812 and 814 on waste channels 806 and 808, respectively, that control the timing and amounts of fluid that flow out of the waste channels 806 and 808. Thus, when the pump controlling flow in channel 804 stops, dropping the flow in channel 804 to zero, the pump 814 connected to waste channel 808 can turn on and pull the appropriate fluid out of the end of channel 804 to remove contaminated fluid. When the pump controlling the flow in channel 804 starts again, and the flow in channel 804 rises above zero, then pump 814 can stop. Alternatively, the pump controlling flow in channel 804 can drop not to zero, but to a flow rate that matched the flow of pump 814 such that the flow in channel 804 matches that of channel 808.

FIG. 8B illustrates a schematic diagram of a mixing junction, generally designated 816, including premixing channels 818 and 820 having connection to waste channels 822 and 824, respectively, at constricted portions 826 and 828, respectively, for removing “contaminate” fluid. Waste channels 830 and 832 can be connected to pumps 834 and 836, respectively, for advancing “contaminate” fluid through the waste channels. Here, the flow rates in the waste channels can be reduced, relative to those depicted in FIG. 8A, owing to the reduced diffusive flux and reduced compliance-driven flow from the mixing junction.

### Pump Strategies for Reducing Shoulders

As stated above, fluid from one channel, such as channel 206 in FIG. 2, at mixing junction 210 can diffuse into the fluid in adjacent channel 208 when the fluid in adjacent channel 208 is stationary, or compliance-driven flows can push fluid from channel 206 into channel 208. This will result in shoulders in a desired concentration gradient at mixing junction 210 when the stationary fluid having “contaminate” fluid is subsequently advanced to mixing junction 210. Furthermore, shoulders can be generated when pumps 104 and 106 fails to generate the commanded flows. Under all three of these circumstances, shoulders can be reduced or eliminated by implementing certain pumping strategies to advance the fluid while achieving the desired concentration gradient runs.

### Minimize the Time Period Fluid Flow is Held Stationary in a Channel

As stated above, when fluid in channel 208 is held stationary at mixing junction 210, fluid from adjacent channel 206 can diffuse or flow into the stationary fluid. The longer the fluid in channel 208 is held stationary, the greater the amount of “contaminate” fluid and, thus, the shoulder on the concentration gradient will be larger. The amount of “contaminate” fluid can therefore be reduced by minimizing the time that fluid flow in channel 208 is held stationary between advancing the fluid.

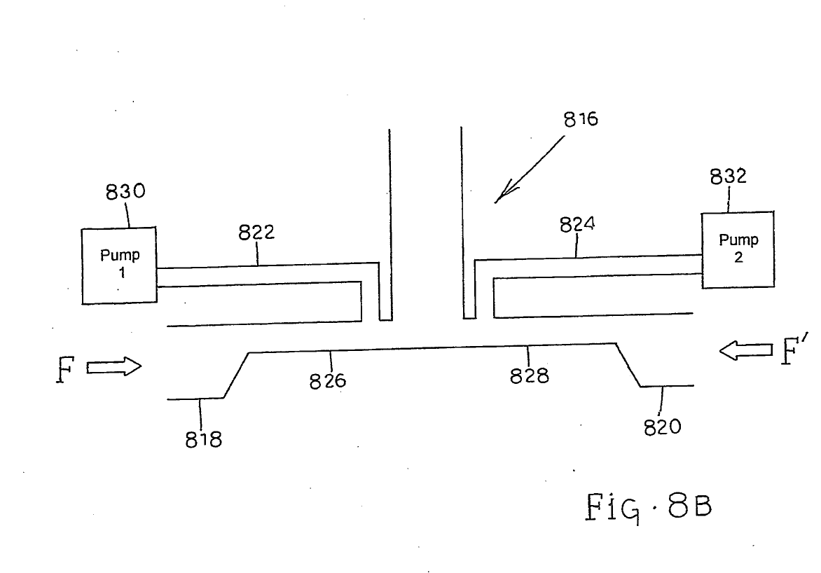

FIG. 9 illustrates a graph showing an exemplary flow velocity profile for reducing undesirable diffusion of fluid by minimizing the time that the fluid in a channel, such as channel 206 shown in FIG. 2, at mixing junction 210 is held stationary. The graph represents the relative flow velocity profile generated by one of two pumps, such as pump 104 shown in FIG. 1, for advancing fluids through channels 206 and 208, respectively, to mixing junction 210. Pumps 104 and 106 generate fluid flow velocities for achieving a continuous, variable concentration gradient at mixing junction 210. Pumps 104 and 106 can continuously produce a total volumetric flow rate that can be kept constant. As shown in the graph, the relative value of the flow velocity generated by pump 104 appears “sawtooth” in shape and reaches a maximum 100% and a minimum 0% of the total volumetric flow rate. Thus, pump 104 generates a minimum and maximum relative flow velocity of 0% and 100%, respectively, of the total volumetric flow rate for a minimum amount of time. The other pump, pump 106, generates a “mirroring” flow velocity in order to achieve a combined volumetric flow velocity of 100%. Because the flow of either pump 104 and 106 is a relative flow velocity of 0% for a minimal time, there is a minimal time period when fluid flow in either of two channels 206 or 208 is held stationary. This result is achieved while still realizing a full range of concentration gradient over time.

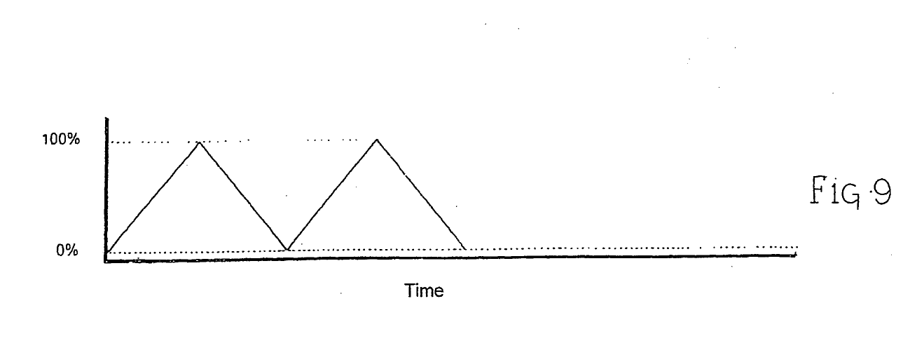

FIG. 10 illustrates a graph showing a series of exemplary continuous, variable concentration gradient runs illustrating the effect of the exemplary profile of FIG. 9. Graph lines 1000 and 1002 represent the varying flow velocity profiles generated by first and second pump 104 and 106, respectively, for advancing fluids through channels 206 and 208, respectively. The fluid flow in channels 206 and 208 reach a maximum relative flow velocity of 100% and minimum relative flow velocity of 0%, wherein the fluid in corresponding channel 206 or 208 is held stationary at 0%. The graph shows the relative flow velocities being held at 0% for shorter durations for each succeeding concentration gradient run. The next to last concentration gradient is run with the fluid being held stationary nearly instantaneously. Graph line 1004 represents the concentration gradient of fluorescent molecules present in mixing channel 212 of mixing junction 210 (as detected with detection equipment 110 shown in FIG. 1) and shows that the shoulders are reduced as the relative fluid velocity is held at 0% for shorter durations. The last concentration gradient run shows the relative fluid velocity being held at 0% for a long period and that this results in shoulders again.

Alternatively, when mixing junction 210 is connected to more than two premixing channels, the fluid flow velocities corresponding to each of the channels is controlled to generate a relative value of 0% for no more than a minimal amount of time. The combined relative fluid velocities of all the pumps can be maintained at a combined 100% of the total volumetric flow rate at all times.

### Preventing the Fluid Flow Rate from Going to Zero

Shoulders at a mixing junction, such as mixing junction 210 shown in FIG. 2, can be eliminated or substantially reduced by preventing the fluid in any of channels 206 and 208 from being held stationary. This strategy can be implemented by controlling pump 104 and 106, such as with computer 108, to prevent or substantially minimize the output of pumps 104 and 106 from going below a predetermined threshold.

This strategy can also be used to overcome stiction in the pump mechanism and to compensate in a servo-controlled system for low encoder resolution at flows near zero. If the pump does not go to zero flow rate, then stiction will not occur. Similarly, if a servo-controlled pump is never driven at flow rates below it's precision, then the pump can produce the commanded flow.

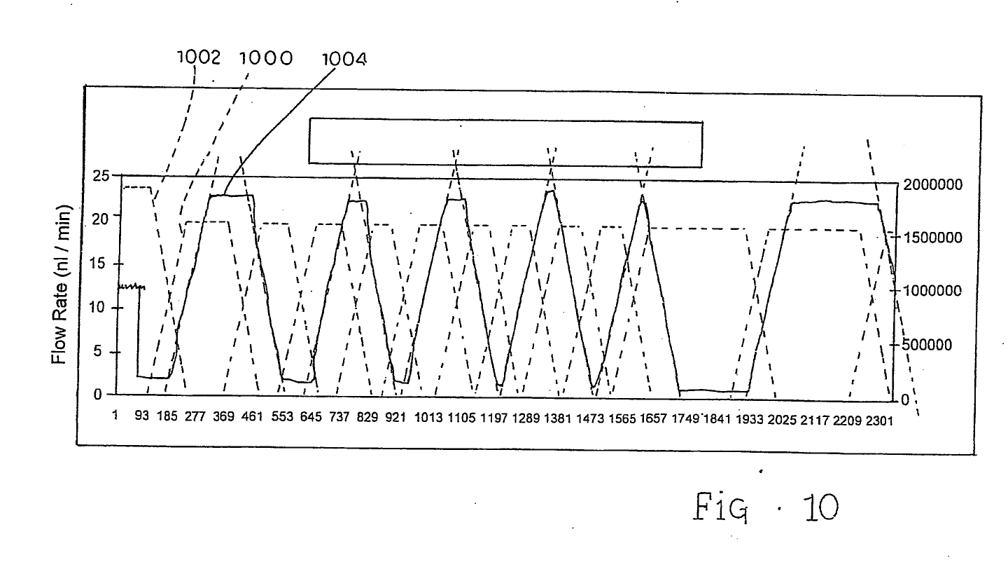

FIG. 11 illustrates a graph showing an exemplary flow velocity profile for eliminating or substantially reducing undesirable diffusion of fluid by eliminating the time that the fluid in a channel at the mixing junction is held stationary. The graph represents the flow velocity profile for pump 104 for advancing fluids through channel 206 to mixing junction 210. Pumps 104 and 106 can continuously produce a total volumetric flow rate that can be kept constant. As shown in the graph, the relative value of the flow velocity generated by pump 104 never reaches a value less than 2%. Alternatively, the relative flow velocity can be controlled to never generate an output less than any predetermined amount. Pump 104 never generates a relative flow velocity greater than 98% because the relative flow velocity generated by pump 106 is never less than of 2% and pumps 104 and 106 generate “mirror” outputs for generating a combined volumetric flow velocity of 100%. Because the relative flow velocity is never 0%, there can be no diffusion from the fluid in channel 208 to channel 206. Similarly, this prevents the pressure difference across mixing junction 210 from generating compliance flows. Thus, shoulders can be eliminated by simply preventing diffusion or compliance-driven flows from being generated.

Alternatively, when mixing junction 210 is connected to more than two premixing channels, the fluid flow velocities corresponding to each of the channels is controlled to prevent the pump from generating relative flow velocity less than a minimal amount, such as 2%. The combined relative fluid velocities of all the pumps can be maintained at a combined 100% of the total volumetric flow rate at all times.

It is frequently desirable to hold the flow at 0% for a finite period of time in one of channels 206 and 208 for the purpose of obtaining a stable baseline reading from, for example, a biochemical reaction. Thus, if it is necessary to get a stable measure of a chemical reaction at 0% of one reagent, for example an enzyme inhibitor, then it is usually necessary to hold the flow of the inhibitor at zero to be certain that any inhibitor in the channel after mixing region 212 is completely flushed out. If the flow must be held at zero for a duration long enough to produce a shoulder that interferes with measurements, then one of the following pump strategies can be applied.

### Bursting the Fluid Flow

Typically, when running a continuous variable concentration gradient at a mixing junction, such as mixing junction 210 shown in FIG. 2, it is desired to run relative flow velocities in channels 206 and 208 from 0%, or stationary, to 100% of the combined volumetric flow velocity. As stated above, “contaminate” fluid can diffuse or flow from one channel, one of channels 206 and 208, to the other when the fluid in one of the channels 206 or 208 is held stationary. According to one pump strategy for achieving a concentration gradient having reduced or eliminated shoulders, the “contaminate” fluid in channels 206 and 208 can be quickly ejected from one of channels 206 or 208 prior to running a concentration gradient from a flow rate of 0% in one of channels 206 and 208. This can be achieved by “bursting” the output of one of pumps 104 or 106 associated with either channel 206 or 208.

This strategy can also be used to overcome stiction in the pump mechanism and to compensate in a servo-controlled system for low encoder resolution at flows near zero. If the shoulder is generated by stiction, then the burst in the commanded moves can start the mechanism moving, without actually generating a pulse in the motion of the pump—the pulse is large enough to overcome the stiction but not to accelerate the motor beyond the desired flow rate. Similarly, the pulse can start a servo-controlled pump to start flowing even though the control system is receiving no instructions from the feedback mechanism when the flow rate is below the precision of the system.

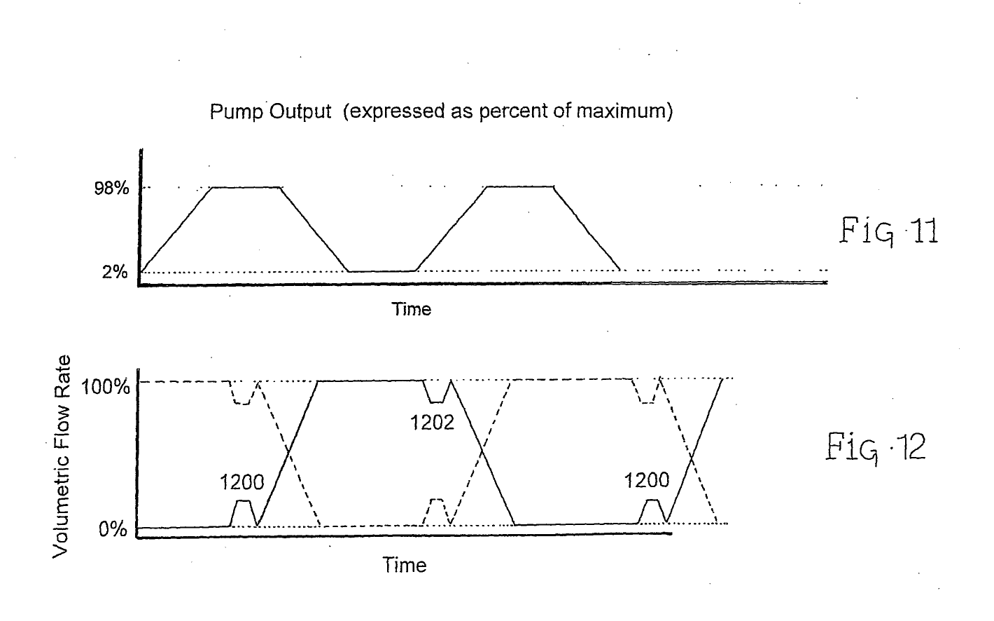

FIG. 12 illustrates a graph showing an exemplary flow velocity profile for ejecting “contaminate” fluid, or achieving the commanded flow rate, prior to running a concentration gradient. The graph represents the relative flow velocity profile generated by one of two pumps, such as pumps 104 and 106 shown in FIG. 1, for pumping fluids through channels, such as channels 206 and 208 shown in FIG. 2, respectively, to mixing junction 210. Pumps 104 and 106 generate fluid flow velocities for achieving a continuous, variable concentration gradient at mixing junction 210. As shown in the graph, pump 104 generates a “burst” output, indicated by reference numeral 1200, for a predetermined period of time to eject “contaminate” fluid in channel 206 just prior to running a concentration gradient from a relative flow velocity of 0%. The concentration gradient can be run immediately after the “burst” flow to prevent fluids from again diffusing or flowing into channel 206. The “burst” flow can have a maximum of approximately 20% of the total volumetric flow rate. The “burst” flow can displace a volume that at least equals the volume of fluid contaminated by diffusion or flow. Thus, a more rapid or longer duration “burst” flow is needed if, for example, the flow in one channel is held at zero for longer durations or if the contaminating chemical has a larger coefficient of diffusion or if the temperature of the microfluidic system increases or if compliance is larger. The other fluid flow in channel 106 can “mirror” the relative flow velocity of this fluid flow for achieving a combined output of 100%, if this is desired. As shown in FIG. 11, the output of pump 104 includes “mirror” burst flows, indicated by reference numeral 1202, for mirroring the “burst” flow of pump 106.

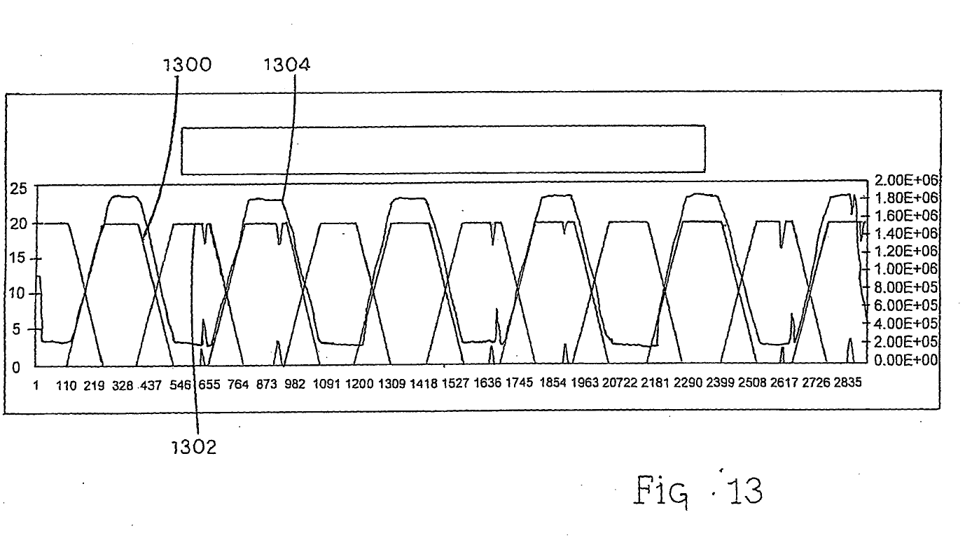

FIG. 13 illustrates a graph showing a series of exemplary continuous, variable concentration gradient runs for a mixing junction connected to two premixing channels, and employing the exemplary flow profile shown in FIG. 12. Graph lines 1300 and 1302 represent the varying flow velocity profiles generated by pumps 104 and 106, respectively, for advancing fluids through channels 206 and 208, respectively. The fluid flow in channels 206 and 208 reach a maximum relative flow velocity of 100% and minimum relative flow velocity of 0%, wherein the fluid in the other channel, channel 206 or 208, is held stationary at the minimum output. The graph shows “burst” flows just prior to the run of every other concentration gradient. The resulting concentration gradient is indicated by graph line 1304. Ascending and descending gradients show reduced shoulders.

Alternatively, when mixing junction 210 is connected to more than two premixing channels, the fluid flow velocities corresponding to each of the channels is controlled to produce a “burst” flow prior to running a concentration gradient. The combined relative fluid velocities of all the pumps can be maintained at a combined 100% of the total volumetric flow rate at all times.

### Slowly Flushing the Fluid

As stated above, before running a concentration gradient, any “contaminate” fluid can be ejected from one of channels, such as channels 206 or 208 shown in FIG. 2, for reducing shoulders. According to one embodiment, this can also be achieved by slowly flushing out one of channels 206 or 208 just prior to running the concentration gradient.

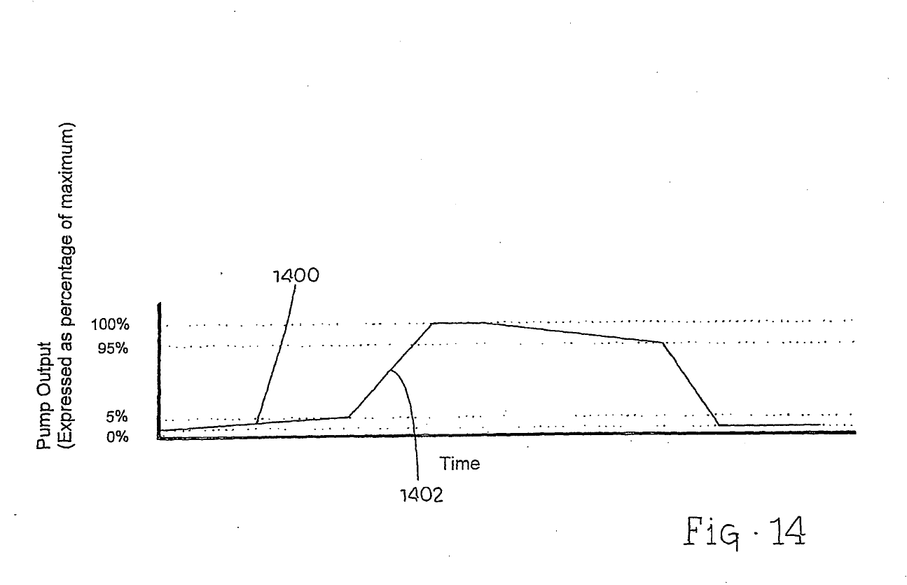

FIG. 14 illustrates a graph showing an exemplary flow velocity profile for ejecting “contaminate” fluid prior to running a concentration gradient. The graph represents the flow velocity profile for one of two pumps, such as pumps 104 or 106 shown in FIG. 1, for advancing fluids through channels 206 or 208, shown in FIG. 1, to a mixing junction. Pumps 104 and 106 can continuously produce a total volumetric flow rate that can be kept constant. FIG. 14 shows the relative value of the flow velocity generated by pump 104. Pump 104 generates a shallow gradient, indicated by reference numeral 1400, prior to running a normal concentration gradient, indicated by reference numeral 1402, beginning at approximately 5% relative flow velocity. The shallow gradient 1400 is run for a predetermined period sufficient to pump a volume at least equal to the volume of the contaminate fluid. Any “contaminate” fluid is removed from channel 206 by the shallow gradient 1400 just prior to running a normal concentration gradient.

Alternatively, when mixing junction 210 is connected to more than two channels, the fluid flow velocites corresponding to each of the channels is controlled to output a shallow gradient prior to running a concentration gradient. The combined relative fluid velocities of all the pumps can be maintained at a combined 100% of the total volumetric flow rate at all times.

### Additional Embodiment of a Mixing Junction

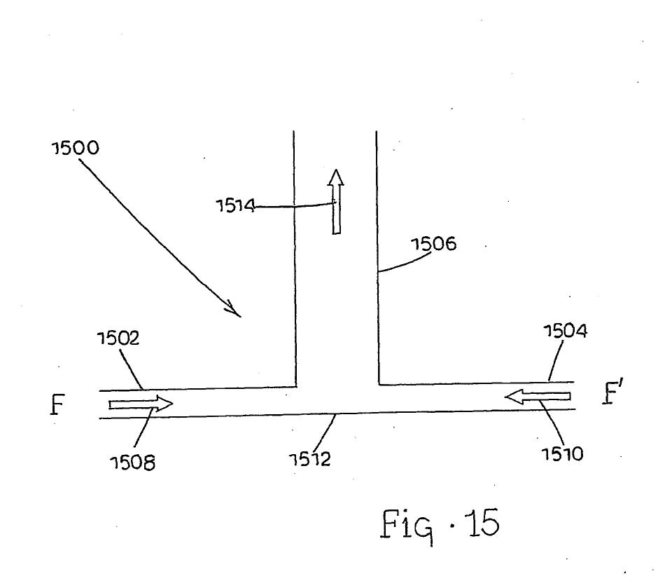

FIG. 15 illustrates a schematic diagram of a mixing junction, generally designated 1500, according to another embodiment. Mixing junction 1500 can be a portion of a microfludic chip and can include a first and second channel 1502 and 1504 for advancing fluids to a mixing channel 1506. A first and second fluid F and F′ can be advanced to mixing channel 1506 through channels 1502 and 1504, respectively, in the direction of arrows 1508 and 1510, respectively. Fluids F and F′ can then mix at mixing region 1512 and advance to other elements of the microfluidic system (not shown) in the direction of arrow 1514. To minimize diffusive flux and compliance-driven flow from mixing junction 1512 into channels 1502 and 1504, the cross-sectional areas of channels 1502 and 1504 are smaller than the cross-sectional area of mixing channel 1506. In an alternative embodiment, mixing junction 1500 can include more than two channels for advancing more than two fluids to a mixing region.

### Controlling Adsorption Effects

Adsorption of a molecule to the wall of a microfluidic channel can sometimes present a problem in microfluidic and other miniaturized systems in which the ratio of surface area to volume is many orders of magnitude larger than is found in more conventional approaches, such as for example, dispensing and mixing of solutions in microtiter plates. Adsorption of molecules in microfluidic systems and other miniaturized devices can be a major obstacle to miniaturization as the adsorption can affect molecule concentrations within fluids, thereby negatively impacting data collected from the microfluidic systems or other miniaturized devices. Adsorption driven changes in concentration can be especially problematic for microfluidic systems used to generate concentration gradients.

In some embodiments, the presently disclosed subject matter provides apparatuses and methods for using the same that can decrease the interference of adsorption to concentration dependent measurements, such as in biochemistry reactions including IC₅₀ determinations, by altering the geometry of a microfluidic channel. Although adsorption may not be eliminated, the change in concentration caused by adsorption can be minimized. In general terms, the effects of adsorption on measurements can be minimized by reducing the ratio of channel surface area to fluid volume within the channel (S/V), which also increases diffusion distances. However, as a high surface area to volume ratio can be an unavoidable consequence of the miniaturization of microfluidics, the geometries provided by some embodiments of the presently disclosed subject matter to minimize adsorption consequences are most unexpected by persons in the field of microfluidics. The presently disclosed subject matter provides for, in some embodiments, using large channel diameters in regions of the microfluidic chip most affected by adsorption of reaction components, that is, in regions where a reaction proceeds and/or where measurements are taken. In some embodiments of the presently disclosed subject matter, and with reference to the microfluidic chip embodiment shown in FIG. 2, large channel diameters at a detection point of detection channel 216 can be provided to reduce adsorption effects, as a substitute for or in combination with serpentine channel 214 (also referred to as aging loop).

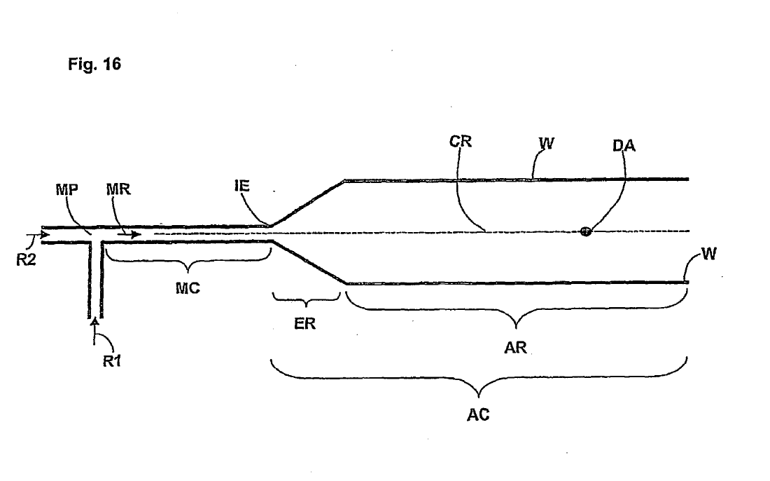

Turning now to FIG. 16, an embodiment of a novel analysis channel of the presently disclosed subject matter is illustrated in a top view. FIG. 16 shows the direction of flow by arrows R1 and R2 of two fluid reagent streams, which can combine at a merge region or mixing point MP. After combining into a merged fluid stream, the reagents within the stream can flow in a direction indicated by arrow MR down a mixing channel MC that can be narrow to permit rapid diffusional mixing of the reagent streams, thereby creating a merged fluid reagent stream. The fluid stream of reagents can then pass into an analysis channel AC, at an inlet or inlet end IE that can have a channel diameter and a cross-sectional area equivalent to that of mixing channel MC. The merged fluid stream can then flow through an expansion region ER that can have a cross-sectional area that can gradually increase and where the surface area to volume ratio can thereby gradually decrease. The merged fluid stream can then continue into an analysis region AR of analysis channel AC with an enlarged cross-sectional area and a reduced surface area to volume ratio. A reaction can be initiated by mixing of the reagent streams at the mixing point MP. However, due to continuity of flow, the flow velocity slows dramatically in analysis region AR of analysis channel AC, and the majority of transit time between mixing point MP and a detection area DA is spent in the larger diameter analysis region AR. Measurements can be made inside this channel, such as with confocal optics, to achieve measurements at detection area DA, which can be located at a center axis CR of analysis region AR of analysis channel AC. Center analysis region CR can be a region equidistant from any channel wall W of analysis channel AC. Thus, the fluid at center analysis region CR of detection area DA can be effectively “insulated” from adsorption at channel walls W. That is, the amount of any reagents removed at channel wall W can be too small, due to the greatly decreased surface area, and the diffusion distance to channel wall W can be too long, due to the greatly increased diffusion distance from center analysis region CR to channel wall W, to greatly affect the concentration at centerline CL. The confocal optics, for example, can reject signal from nearer channel wall W of analysis region AR, permitting measurements to be made at center analysis region CR where the concentration is least affected by adsorption at channel wall W.

A consequence of increasing analysis channel AC cross-section by increasing channel diameter is that the ratio of channel surface area to fluid volume (S/V) within the channel is decreased, relative to a narrower channel. For example, to measure a reaction 3 minutes after mixing, with a volumetric flow rate of 30 nL/min, the reaction should be measured at a point in the channel such that a microfluidic channel section spanning from mixing point MP to detection area DA encloses 90 nL. For an analysis channel with a square cross-section and a diameter of 25 μm, this point is about 144 mm downstream from mix point MP. This channel has a surface area of 1.44×10⁻⁵ square meters, yielding a surface to volume ratio S/V equal to 1.6×10⁵ m⁻¹. For a channel with a diameter of 250 μm, the measurement is made 1.44 mm downstream from mix point MP. This wider channel has a surface area of 1.44×10⁻⁶ square meters, yielding a S/V equal to 1.6×10⁴ m⁻¹, which is 1/10^{th} the S/V of the narrower channel. This alone can decrease ten-fold the removal of compound per unit volume by adsorption.

This geometry change can also decrease the radial diffusive flux of compound. Flow in these small channels is at low Reynolds number, so diffusion from a point in the fluid is the only mechanism by which compound concentration changes radially in a microfluidic channel. Increasing the radius of the channel, thereby decreasing the radial diffusive flux, therefore, means that the concentration of compound at center analysis region CR of analysis region AR can be less affected by adsorption than in the smaller upstream channels.

Thus, increasing the cross-sectional area of analysis region AR of analysis channel AC can both decrease the amount of adsorption at the wall per unit volume and decrease the rate of flux of compound from center analysis region CR to any of channel walls W. Both together mean that the concentration at center analysis region CR can decrease more slowly due to adsorption of compound.

Further, in all embodiments, the surface area of all channels exposed to compounds, not just analysis channel AC, can preferably be kept minimal, especially those channels through which concentration gradients flow. This can be accomplished by making channels as short as practicable. Additionally, when the volume contained by a channel must be defined (e.g. where the channel must contain a volume of 50 mL), it is best to use larger diameters/shorter lengths wherever possible to reduce S/V.

Another benefit of increasing analysis channel AC cross-section by increasing channel diameter is that the length of the channel down which the fluid flows can be reduced. In the example given earlier, a channel with 25 μm diameter needed to be 144 mm long to enclose 90 nl whereas the channel with 250 μm diameter needed to be only 1.44 mm long. This shorter channel can be much easier to fabricate and has a much smaller footprint on a microfluidic chip.

Still another benefit of increasing analysis channel AC cross-section is that it will behave like an expansion channel, which filters noise out of chemical concentration gradients, as disclosed in co-pending, commonly assigned U.S. Provisional Application entitled MICROFLUIDIC SYSTEMS, DEVICES AND METHODS FOR REDUCING NOISE GENERATED BY MECHANICAL INSTABILITIES, U.S. Provisional Application No. 60/707,245 (Attorney Docket No. 447/9913/2), herein incorporated by reference in its entirety. The result is that signal to noise is larger in an analysis channel AC with larger cross-section.

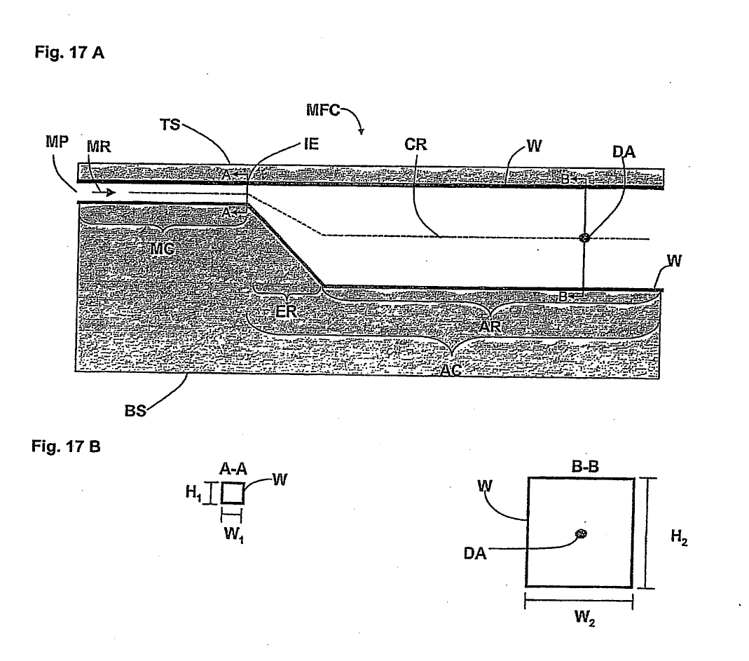

FIG. 17A presents a cross-sectional side view of a portion of a microfluidic chip MFC comprising mixing channel MC and analysis channel AC depicted in FIG. 16. Microfluidic chip MFC shown in FIG. 17A can be constructed by machining channels into a bottom substrate BS and enclosing channels by bonding a top substrate TS to bottom substrate BS or otherwise forming channels within microfluidic chip MC with bottom substrate BS and top substrate TS being integral. In FIG. 17A, only the flow of merged reagent fluid stream having a flow direction indicated by arrow MR after mixing point MP is shown. Flow in a microfluidic channel can be at low Reynolds number, so the streamline of fluid that flows along center analysis region CR of the narrower mixing channel MC can travel at the mid-depth along entire mixing channel MC, becoming center analysis region CR of analysis region AR of analysis channel AC. Detection area DA can reside along center analysis region CR at a point sufficiently far downstream of mixing channel MC to permit the reaction to proceed to a desired degree.

Analysis channel AC can approximate a circular cross-section as closely as possible to produce the smallest ratio of surface area to volume, and also to produce the largest diffusion distance from centerline center analysis region CR to a channel wall W. However, microfluidic channels may not be circular in cross-section due to preferred manufacturing techniques. Rather, they can be more likely square in cross-section, with the exact shape depending on the technique used to form the channels. For such channels, a cross-section of analysis channel AC, particularly within analysis region AR, can have an aspect ratio as close to one as possible or, more precisely stated, the distance from center analysis region CR to channel wall W can be as nearly constant in all radial directions as possible.

FIG. 17B shows two different cross-sectional views along analysis channel AC as viewed along cutlines A-A and B-B. Both cross-sectional views illustrate an aspect ratio approximating one. That is, for cross-section A-A, height H₁ of mixing channel MC is approximately equal to width W₁ of mixing channel MC, such that H₁/W₁ approximately equals one. Comparably, for cross-section B-B, height H₂ of mixing channel MC is approximately equal to width W₂ of mixing channel MC, such that H₂/W₂ approximately equals one.

FIG. 17B further shows that the cross-sectional area (H₂×W₂) of analysis region AR at cutline B-B, which is located at detection area DA of analysis region AR, is significantly larger than the cross-sectional area (H₁×W₁) of input end IE at cutline A-A. In some embodiments of the presently disclosed subject matter, the cross-sectional area at detection area DA can be at least twice the value of the cross-sectional area value at input end IE and further upstream, such as in mixing channel MC. Further, in some embodiments, the cross-sectional area at detection area DA can be between about two times and about ten times the value of the cross-sectional area value at input end IE. As shown in cutline B-B of FIG. 17B, detection area DA can be positioned along center analysis region CR approximately equidistant from each of walls W to provide maximal distance from walls W, and thereby minimize effects of molecule adsorption to walls W. It is clear from FIG. 17B that the larger cross-sectional area at cutline B-B can provide both greater distance from walls W and smaller S/V than the smaller cross-sectional area at cutline A-A, both of which can reduce adsorption effects on data analysis, as discussed herein. Although detection area DA is shown in the figures as a circle having a distinct diameter, the depiction in the drawings is not intended as a limitation to the size, shape, and/or location of detection area DA within the enlarged cross-sectional area of analysis region AR. Rather, detection area DA can be as large as necessary and shaped as necessary (e.g. circular, elongated oval or rectangle, etc.) to acquire the desired data, while minimizing size as much as possible to avoid deleterious adsorption effects on the data. Determination of the optimal balance of size, shape and location while minimizing adsorption effects is within the capabilities of one of ordinary skill in the art without requiring undue experimentation.

Additional details and features of analysis channel AC are disclosed in co-pending, commonly assigned U.S. Provisional Application entitled METHODS AND APPARATUSES FOR REDUCING EFFECTS OF MOLECULE ADSORPTION WITHIN MICROFLUIDIC CHANNELS, U.S. Provisional Application No. 60/707,366 (Attorney Docket No. 447/99/8), herein incorporated by reference in its entirety.

In some embodiments, the presently disclosed subject matter provides apparatuses and methods for making and using the same that can decrease the interference of adsorption to concentration dependent measurements, such as in biochemistry reactions (including IC₅₀ determinations), by reducing adsorption of molecules to microfluidic channel walls. In some embodiments, the presently disclosed subject matter provides microfluidic chips comprising channels and chambers with treated surfaces exhibiting reduced adsorption of molecules to channel walls, such as for example hydrophilic surfaces, and methods of preparing and using the same. In some embodiments, methods of preparing hydrophilic surfaces by treating hydrocarbon-based plastics, such as for example polycarbonate, with fluorine gas mixtures are provided. In some exemplary embodiments, the methods comprise contacting a mixture of fluorine gas and an inert gas with the surface to be treated, then flushing the surface with air. This treatment results in plastic surfaces of increased hydrophilicity (increased surface energy). Hydrophobic solutes, in particular known and potential drug compounds, in solutions in contact with these treated hydrophilic plastic surfaces are less likely to be adsorbed onto the more hydrophilic surfaces. Plastics comprising the treated surfaces are useful in providing many improved drug discovery and biochemical research devices for handling, storing, and testing solutions containing low concentrations of hydrophobic solutes.

Additional details and features of hydrophilic surfaces in microfluidic systems and methods of making and using the same are disclosed in co-pending, commonly owned U.S. Provisional Application entitled PLASTIC SURFACES AND APPARATUSES FOR REDUCED ADSORPTION OF SOLUTES AND METHODS OF PREPARING THE SAME, U.S. Provisional Application No. 60/707,288 (Attorney Docket No. 447199/9).

Further, in some embodiments of the presently disclosed subject matter, microfluidic systems are provided comprising an analysis channel with an enlarged cross-sectional area and a reduced surface area to volume ratio and further comprising channels and chambers with hydrophilic surfaces.

It will be understood that various details of the subject matter can be changed without departing from the scope of the subject matter. Furthermore, the foregoing description is for the purpose of illustration only, and not for the purpose of limitation.

1. A microfluidic device for combining fluids in a fluid mixing region, the microfluidic device comprising:
(a) a fluid mixing region including an inlet for receiving fluids for mixing;
(b) a first microscale channel including a first end connected to the inlet for advancing a first fluid to the mixing region; and
(c) a second microscale channel including a first end connected to the inlet for advancing a second fluid to the mixing region, wherein the first ends of the first and second microscale channels are in fluid communication at the inlet, and wherein the first end of the second microscale channel includes a constricted flow portion.

2. The microfluidic device of claim 1, wherein the constricted flow portion is operable to reduce diffusion of the first fluid from the first microscale channel into the second microscale channel.

3. The microfluidic device of claim 1, wherein the constricted flow portion is operable to reduce diffusion of the second fluid from the second microscale channel into the fluid of the mixing region.

4. The microfluidic device of claim 1, wherein the constricted flow portion extends substantially for a length of the first end of the second microscale channel.

5. The microfluidic device of claim 1, wherein the second microscale channel comprises a second end opposing the first end, wherein the second end has a greater cross-sectional area than the constricted flow portion.

6. The microfluidic device of claim 1, wherein the first end of the first microscale channel includes a constricted flow portion for reducing diffusion of the second fluid from the second microscale channel into the first microscale channel.

7. The microfluidic device of claim 6, wherein the constricted flow portion is operable to reduce diffusion of the first fluid from the first microscale channel into the fluid of the mixing region.

8. The microfluidic device of claim 6, wherein the constricted flow portion of the first microscale channel extends substantially a length of the first end of the first microscale channel.

9. The microfluidic device of claim 6, wherein the first microscale channel further includes a second end opposing the first end, wherein the second end has a greater cross-sectional area than the constricted flow portion of the first microscale channel.

10. The microfluidic device according to claim 1 comprising more than two microscale channels advancing fluids to the mixing region, wherein at least one of the more than two microscale channels includes a constricted flow portion.

11. The microfluidic device of claim 10, wherein the at least one constricted flow portion is operable to reduce diffusion between the fluid in the at least one microscale channel and the fluid in the mixing region.

12. The microfluidic device according to claim 1, wherein the microfluidic device comprises a microfluidic chip.

13. The microfluidic device of claim 1, wherein the mixing region and the first and second microscale channels are fabricated in a substrate.

14. The microfluidic device of claim 13, wherein the substrate comprises a polymer.

15. The microfluidic device of claim 13, wherein the first substrate comprises a material selected from the group consisting of silicon, silica, glass, quartz, sapphire, zinc oxide, alumina, Group III-V compounds, and combinations thereof.

16. The microfluidic device of claim 13, comprising a second substrate bonded to the first substrate for enclosing the mixing region and first and second microscale channels.

17. The microfluidic device of claim 1, wherein the second microscale channel comprises a waste channel connected to the first end of the second microscale channel for removing the first fluid diffused into the first end of the second microscale channel.

18. The microfluidic device of claim 17, wherein the waste channel is connected to the constricted flow portion.

19. The microfluidic device of claim 1, wherein the first microscale channel comprises a waste channel connected to the first end of the first microscale channel for removing the second fluid diffused into the first end of the first microscale channel.

20. The microfluidic device of claim 19, wherein the first end comprises a constricted flow portion, and the waste channel is connected to the constricted flow portion.

21-48. (canceled)

49. A method for fabricating a microfluidic device having waste channels, the method comprising:
(a) providing a substrate;
(b) forming a fluid mixing region in the substrate, the fluid mixing region including an inlet for receiving fluids for mixing;
(c) forming a first microscale channel in the substrate, the first microscale channel including an end connected to the inlet for advancing a first fluid to the mixing region;
(d) forming a second microscale channel in the substrate, the second microscale channel including an end connected to the inlet for advancing a second fluid to the mixing region;
(e) forming a first waste channel in the substrate, the first waste channel connected to the end of the first microscale channel for removing the second fluid diffused into the end of the first microscale channel; and
(f) forming a second waste channel in the substrate, the second waste channel connected to the end of the second microscale channel for removing the first fluid diffused into the end of the second microscale channel.

50-67. (canceled)

68. A method for controlling the flow of fluids into a fluid mixing region, the method comprising:
(a) providing a microfluidic device, comprising:
(i) a microfluidic chip including first and second microscale channels having ends connected at a junction for advancing a first and second fluid, respectively, to the junction for mixing; and
(ii) a first pump connected to the first microscale channel and operable to advance the first fluid through the first microscale channel to the junction; and
(b) controlling the first pump to hold the first fluid in position no greater than a predetermined time period before advancing the first fluid to the junction.

69-81. (canceled)
